(19) United States
(12) Patent Application Publication
(10) Pub. No.: US 2009/0152750 A1
(43) Pub. Date: Jun. 18, 2009

(54) Vacuum Drug Pellet Molding

(76) Inventor: Cesario Dos Santos, Aliso Viejo, CA (US)

Correspondence Address: ALCON, IP LEGAL, TB4-8, 6201 SOUTH FREEWAY, FORT WORTH, TX, 76134, US

(21) Appl. No.: 11/955,035

(22) Filed: Dec. 12, 2007

(51) Int. Cl. B29C 44/42; B29C 44/22

(52) U.S. Cl. 264/6; 425/4 C

(57) ABSTRACT

A mold apparatus includes a container, a temperature control device, a distribution manifold, a plurality of dispensers, a mold, a bottom plate for the mold, and a vacuum chamber. The temperature control device at least partially surrounds the container. The distribution manifold is located downstream from the container. The plurality of dispensers are coupled to the distribution manifold. The mold has a plurality of cavities for receiving a mixture from the plurality of dispensers. The bottom plate is located on a bottom surface of the mold. The vacuum chamber keeps the container, distribution manifold, plurality of dispensers and mold in a vacuum. A drug and compound mixture are brought to a temperature other than room temperature and dispensed into the mold under a vacuum to form pellets.

### BACKGROUND OF THE INVENTION

The present invention relates to molding drug pellets for an injection device and more particularly to a molding apparatus for a drug suspended in a phase transition compound.

Several diseases and conditions of the posterior segment of the eye threaten vision. Age related macular degeneration (ARMD), choroidal neovascularization (CNV), retinopathies (e.g., diabetic retinopathy, vitreoretinopathy), retinitis (e.g., cytomegalovirus (CMV) retinitis), uveitis, macular edema, glaucoma, and neuropathies are several examples.

These, and other diseases, can be treated by injecting a drug into the eye. Such injections are typically done manually using a conventional syringe and needle. FIG. 1 is a perspective view of a prior art syringe used to inject drugs into the eye. In FIG. 1, the syringe includes a needle 105, a luer hub 110, a chamber 115, a plunger 120, a plunger shaft 125, and a thumb rest 130. As is commonly known, the drug to be injected is located in chamber 115. Pushing on the thumb rest 130 causes the plunger 120 to expel the drug through needle 105.

In using such a syringe, the surgeon is required to pierce the eye tissue with the needle, hold the syringe steady, and actuate the syringe plunger (with or without the help of a nurse) to inject the fluid into the eye. Fluid flow rates are uncontrolled. The volume injected is typically not controlled in an accurate manner because reading the vernier is subject to parallax error. Tissue damage may occur due to an “unsteady” injection.

An effort has been made to control the delivery of small amounts of liquids. A commercially available fluid dispenser is the ULTRA™ positive displacement dispenser available from EFD Inc. of Providence, R.I. The ULTRA dispenser is typically used in the dispensing of small volumes of industrial adhesives. It utilizes a conventional syringe and a custom dispensing tip. The syringe plunger is actuated using an electrical stepper motor and an actuating fluid. Parker Hannifin Corporation of Cleveland, Ohio distributes a small volume liquid dispenser for drug discovery applications made by Aurora Instruments LLC of San Diego, Calif. The Parker/Aurora dispenser utilizes a piezo-electric dispensing mechanism. Ypsomed, Inc. of Switzerland produces a line of injection pens and automated injectors primarily for the self-injection of insulin or hormones by a patient. This product line includes simple disposable pens and electronically-controlled motorized injectors.

U.S. Pat. No. 6,290,690 discloses an ophthalmic system for injecting a viscous fluid (e.g. silicone oil) into the eye while simultaneously aspirating a second viscous fluid (e.g. perflourocarbon liquid) from the eye in a fluid/fluid exchange during surgery to repair a retinal detachment or tear. The system includes a conventional syringe with a plunger. One end of the syringe is fluidly coupled to a source of pneumatic pressure that provides a constant pneumatic pressure to actuate the plunger. The other end of the syringe is fluidly coupled to an infusion cannula via tubing to deliver the viscous fluid to be injected.

When a portable hand piece is used to inject a drug into the eye, it is important to provide a proper drug dosage. In one case, a phase transition compound or reverse gelation compound contains the drug. At room temperature, these compounds are in a solid state and have the consistency of wax. Because of their consistency, dosing an injector with these compounds can be difficult. The compounds can be brought to a more liquid state and drawn into the injector. However, this is a time consuming process that may not provide proper dosage. Drug pellets can be made by bringing the compounds to a more liquid state and sending the compounds through a drug molding apparatus. If the mold apparatus is properly designed, then a reliable dosage results.

### SUMMARY OF THE INVENTION

In one embodiment consistent with the principles of the present invention, the present invention is a mold apparatus that includes a container, a temperature control device, a distribution manifold, a plurality of dispensers, a mold, a bottom plate for the mold, and a vacuum chamber. The temperature control device at least partially surrounds the container. The distribution manifold is located downstream from the container. The plurality of dispensers are coupled to the distribution manifold. The mold has a plurality of cavities for receiving a mixture from the plurality of dispensers. The bottom plate is located on a bottom surface of the mold. The vacuum chamber keeps the container, distribution manifold, plurality of dispensers and mold in a vacuum. A drug and compound mixture are brought to a temperature other than room temperature and dispensed into the mold under a vacuum to form pellets.

In another embodiment consistent with the principles of the present invention, the present invention is a mold apparatus having a container, a mixer located in the container, a drive for driving the mixer, a temperature control device at least partially surrounding the container, a controller for controlling the operation of the mixer and the temperature control device, a distribution manifold located downstream from the container, a plurality of dispensers coupled to the distribution manifold, a mold comprising a plurality of cavities for receiving a mixture from the plurality of dispensers, a bottom plate located on a bottom surface of the mold, and a vacuum chamber for keeping the container, distribution manifold, plurality of dispensers and mold in a vacuum. A drug and compound mixture are brought to a temperature other than room temperature and dispensed into the mold under a vacuum to form pellets.

In another embodiment consistent with the principles of the present invention, the present invention is a method of making drug/compound pellets comprising: heating a mold apparatus; mixing a drug and phase transition compound; heating the mixture of the drug and phase transition compound; transferring the mixture into a plurality of dispensers; under a vacuum, dispensing the mixture into the mold; cooling the mold; and removing a finished pellet from the mold.

It is to be understood that both the foregoing general description and the following detailed description are exemplary and explanatory only and are intended to provide further explanation of the invention as claimed. The following description, as well as the practice of the invention, set forth and suggest additional advantages and purposes of the invention.

### BRIEF DESCRIPTION OF THE DRAWINGS

The accompanying figures, which are incorporated in and constitute a part of this specification, illustrate several embodiments of the invention and together with the description, serve to explain the principles of the invention.

FIG. 1 is a perspective view of a prior art syringe.

FIG. 2 is a cross section view of a disposable tip segment and a limited reuse assembly according to the principles of the present invention.

FIG. 3 is a drug pellet molding apparatus according to the principles of the present invention.

FIG. 4 is a heated mixing container according to the principles of the present invention.

FIG. 5 is a set of dispensers according to the principles of the present invention.

FIG. 6 is a cross section view of a dispenser according to the principles of the present invention.

FIG. 7 is a mold and mold base plate according to the principles of the present invention.

FIG. 8 is a view of the pellet removal process according to the principles of the present invention.

FIG. 9 is a flow chart of a method of molding pellets with a mold assembly according to the principles of the present invention.

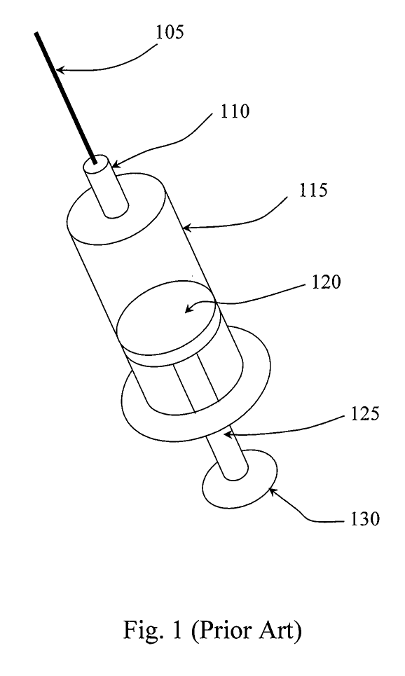

### DETAILED DESCRIPTION OF THE PREFERRED EMBODIMENTS

Reference is now made in detail to the exemplary embodiments of the invention, examples of which are illustrated in the accompanying figures. Wherever possible, the same reference numbers are used throughout the figures to refer to the same or like parts.

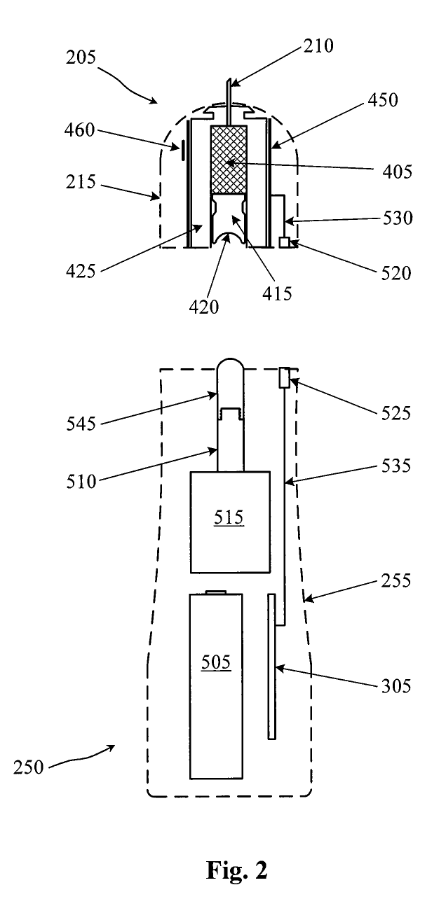

FIG. 2 is a cross section view of a disposable tip segment and a limited reuse assembly according to an embodiment of the present invention. FIG. 2 shows how tip segment 205 interfaces with limited reuse assembly 250. In the embodiment of FIG. 2, tip segment 205 includes plunger interface 420, plunger 415, dispensing chamber housing 425, tip segment housing 215, temperature control device 450, thermal sensor 460, needle 210, dispensing chamber 405, interface 530, and tip interface connector 520. Limited reuse assembly 250 includes mechanical linkage 545, actuator shaft 510, actuator 515, power source 505, controller 305, limited reuse assembly housing 255, interface 535, and limited reuse assembly interface connector 525.

In tip segment 205, plunger interface 420 is located on one end of plunger 415. The other end of plunger 415 forms one end of dispensing chamber 405. Plunger 415 is adapted to slide within dispensing chamber 405. An outer surface of plunger 415 is fluidly sealed to the inner surface of dispensing chamber housing 425. Dispensing chamber housing 425 surrounds the dispensing chamber 405. Typically, dispensing chamber housing 425 has a cylindrical shape. As such, dispensing chamber 405 also has a cylindrical shape.

Needle 210 is fluidly coupled to dispensing chamber 405. In such a case, a substance contained in dispensing chamber 405 can pass through needle 210 and into an eye. Temperature control device 450 at least partially surrounds dispensing chamber housing 425. In this case, temperature control device 450 is adapted to heat and/or cool dispensing chamber housing 425 and any substance contained in dispensing chamber 405. Interface 530 connects temperature control device 450 and thermal sensor 460 with tip interface connector 520.

The components of tip segment 205, including dispensing chamber housing 425, temperature control device 450, and plunger 415 are at least partially enclosed by tip segment housing 215. In one embodiment consistent with the principles of the present invention, plunger 415 is sealed to the interior surface of dispensing chamber housing 425. This seal prevents contamination of any substance contained in dispensing chamber 405. For medical purposes, such a seal is desirable. This seal can be located at any point on plunger 415 or dispensing chamber housing 425.

In limited reuse assembly 250, power source 505 provides power to actuator 515. An interface (not shown) between power source 505 and actuator 515 serves as a conduit for providing power to actuator 515. Actuator 515 is connected to actuator shaft 510. When actuator 515 is a stepper motor, actuator shaft 510 is integral with actuator 515. Mechanical linkage interface 545 is connected to actuator shaft 510. In this configuration, as actuator 515 moves actuator shaft 510 upward toward needle 210 mechanical linkage interface 545 also moves upward toward needle 210.

Controller 305 is connected via interface 535 to limited reuse assembly interface connector 525. Limited reuse assembly interface connector 525 is located on a top surface of limited reuse assembly housing 255 adjacent to mechanical linkage interface 545. In this manner, both limited reuse assembly interface connector 525 and mechanical linkage interface 545 are adapted to be connected with tip interface connector 520 and plunger interface 420 respectively.

Controller 305 and actuator 515 are connected by an interface (not shown). This interface (not shown) allows controller 305 to control the operation of actuator 515. In addition, an interface (not shown) between power source 505 and controller 305 allows controller 305 to control operation of power source of 310. In such a case, controller 305 may control the charging and the discharging of power source 505 when power source 505 is a rechargeable battery.

Controller 305 is typically an integrated circuit with power, input, and output pins capable of performing logic functions. In various embodiments, controller 305 is a targeted device controller. In such a case, controller 305 performs specific control functions targeted to a specific device or component, such as a temperature control device or a power supply. For example, a temperature control device controller has the basic functionality to control a temperature control device. In other embodiments, controller 305 is a microprocessor. In such a case, controller 305 is programmable so that it can function to control more than one component of the device. In other cases, controller 305 is not a programmable microprocessor, but instead is a special purpose controller configured to control different components that perform different functions. While depicted as one component, controller 305 may be made of many different components or integrated circuits.

Tip segment 205 is adapted to mate with or attach to limited reuse assembly 250 as previously described. In the embodiment of FIG. 5, plunger interface 420 located on a bottom surface of plunger 415 is adapted to mate with mechanical linkage interface 545 located near a top surface of limited reuse assembly housing 255. In addition, tip interface connector 520 is adapted to connect with limited reuse assembly interface connector 525. When tip segment 205 is connected to limited reuse assembly 250 in this manner, actuator 515 and actuator shaft 510 are adapted to drive plunger 415 upward toward needle 210. In addition, an interface is formed between controller 305 and temperature control device 450. A signal can pass from controller 305 to temperature control device 450 through interface 535, limited reuse assembly interface connector 525, tip interface connector 520, and interface 530.

In operation, when tip segment 205 is connected to limited reuse assembly 250, controller 305 controls the operation of actuator 515. Actuator 515 is actuated and actuator shaft 510 is moved upward toward needle 210. In turn, mechanical linkage interface 545, which is mated with plunger interface 420, moves plunger 415 upward toward needle 210. A substance located in dispensing chamber 405 is then expelled through needle 210.

In addition, controller 305 controls the operation of temperature control device 450. Temperature control device 450 is adapted to heat and/or cool dispensing chamber housing 425. Since dispensing chamber housing 425 is at least partially thermally conductive, heating or cooling dispensing chamber housing 425 heats or cools a substance located in dispensing chamber 405. Temperature information can be transferred from thermal sensor 460 to controller 305 via any of a number of different interface configurations. This temperature information can be used to control the operation of temperature control device 450. When temperature control device 450 is a heater, controller 305 controls the amount of current that is sent to temperature control device 450. The more current sent to temperature control device 450, the hotter it gets. In such a manner, controller 305 can use a feed back loop utilizing information from thermal sensor 460 to control the operation of temperature control device 450. Any suitable type of control algorithm, such as a proportional integral derivative (PID) algorithm, can be used to control the operation of temperature control device 450.

In various embodiments of the present invention, temperature control device 450 heats a phase transition compound that is located in dispensing chamber 405. This phase transition compound carries a drug that is to be injected into the eye. A phase transition compound is in a solid or semi-solid state at lower temperatures and in a more liquid state at higher temperatures. Such a substance can be heated by temperature control device 450 to a more liquid state and injected into the eye where it forms a bolus that erodes over time. Likewise, a reverse gelation compound may be used. A reverse gelation compound is in a solid or semi-solid state at higher temperatures and in a more liquid state at lower temperatures. Such a compound can be cooled by temperature control device 450 to a more liquid state and injected into the eye where it forms a bolus that erodes over time. As such, temperature control device 450 may be a device that heats a substance in dispensing chamber 405 or a device that cools a substance in dispensing chamber 405 (or a combination of both). After being delivered into the eye, a phase transition compound or reverse gelation compound erodes over time providing a quantity of drug over an extended period of time. Using a phase transition compound or reverse gelation compound provides better drug dosage with fewer injections.

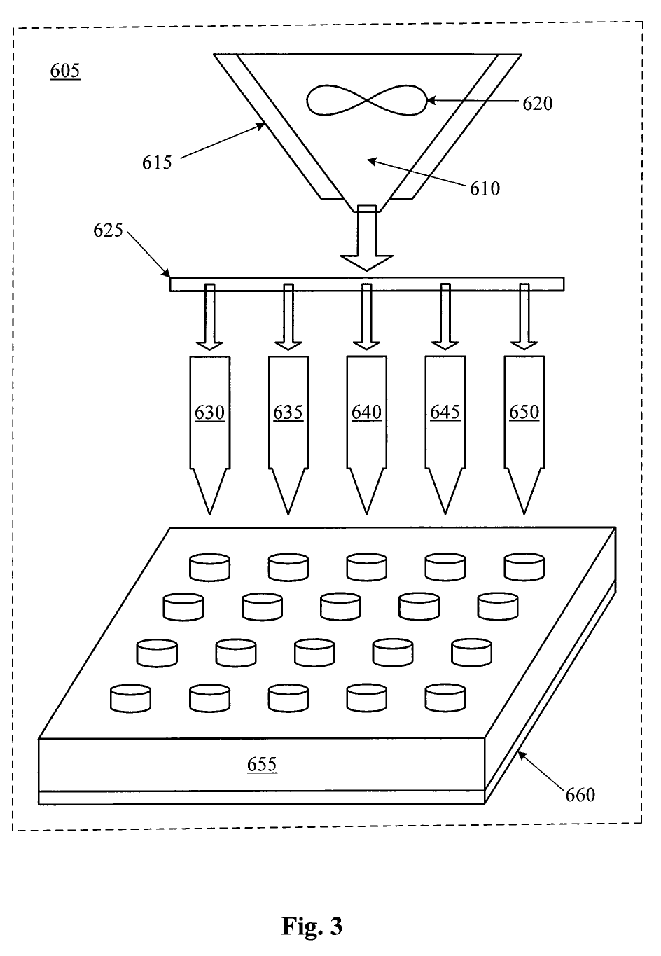

FIG. 3 is a drug pellet molding apparatus according to the principles of the present invention. The apparatus includes a container 610 with a temperature control device 615 and a mixer 620, a manifold 625, a plurality of dispensers 630, 635, 640, 645, 650, a mold 655, and a bottom plate 660. The arrows indicate the direction of flow.

Container 610 is a container that holds the drug/compound mixture. Container 610 allows for the drug/compound mixture to be fed into it from the top. Temperature control device 615 at least partially surrounds container 610 and maintains the drug/compound mixture at a temperature suitable for making pellets. Mixer 620 mixes the drug/compound mixture to keep the drug components of the mixture at a suitable consistent level in the resulting pellets.

The drug/compound mixture is fed into distribution manifold 625. Distribution manifold 625 is coupled to dispensers 630, 635, 640, 645, and 650. In this manner, the drug/compound mixture is fed from container 610 to manifold 625 and to dispensers 630, 635, 640, 645, and 650.

Mold 655 includes a plurality of cavities (denoted by cylinders) into which dispensers 630, 635, 640, 645, and 650 dispense the drug/compound mixture. Each cavity holds an amount of drug/compound mixture that forms one pellet. Bottom plate 660 forms the bottom boundary of the mold. Both mold 655 and bottom plate 660 are preferably made of a thermally conductive material that is approved for contact with a drug. For example, they may be made of glass, a polymer, or like material. In other embodiments, the surface of mold 655 and bottom plate 660 that contacts the drug is coated with such a material. Likewise, the other parts of the system, including the interior of container 610, the interior of distribution manifold 625, and the interior of dispensers 630, 635, 640, 645, and 650, are also made with or coated with a material that is suitable for contact with a pharmaceutical.

All of the components depicted in FIG. 3 are contained in a vacuum chamber 605. As such, the pellet forming process is conducted under vacuum. This greatly reduces the amount of air entrapped in the drug/compound mixture. Excess air in the mixture can lead to unreliable and inconsistent pellet doses and undesirable operation of the injection device. For example, air entrapped in the pellet expands more rapidly than the compound when it is heated. This expansion of air can lead to premature expulsion of drug/compound during the injection process. In addition, the volume of air entrapped in a pellet reduces a like volume of drug/compound resulting in an imprecise dosage per pellet.

For example, pellets can be made from a drug suspended in a phase transition compound. In such a case, the apparatus of FIG. 3 is prepared for use. Mold 655 is secured to bottom plate 660. In this position, bottom plate 660 forms a fluid tight seal against the bottom of mold 655. A drug/compound mixture is fed into container 610 which is heated by temperature control device 615. Since container 610 is heated, the drug/compound mixture is also heated to a liquid state. Mixer 620 keeps the mixture mixed. The drug/compound mixture is dispensed into distribution manifold 625 (which is also heated to keep the mixture in a liquid state). The distribution manifold feeds the drug/compound mixture into dispensers 630, 635, 640, 645, and 650. These dispensers are also heated. The drug compound mixture is dispensed from dispensers 630, 635, 640, 645, and 650 into the cavities in mold 655. Dispensers 630, 635, 640, 645, and 650 are designed to dispense precise amounts of the mixture. This dispensing process is performed under vacuum to reduce the amount of air entrapped in the resulting pellets. After the cavities in mold 655 are filled, the mold 655 and bottom plate 660 are cooled so that the drug/compound mixture solidifies to form pellets. These pellets are removed from the mold and placed in the dispensing chamber of an injection device.

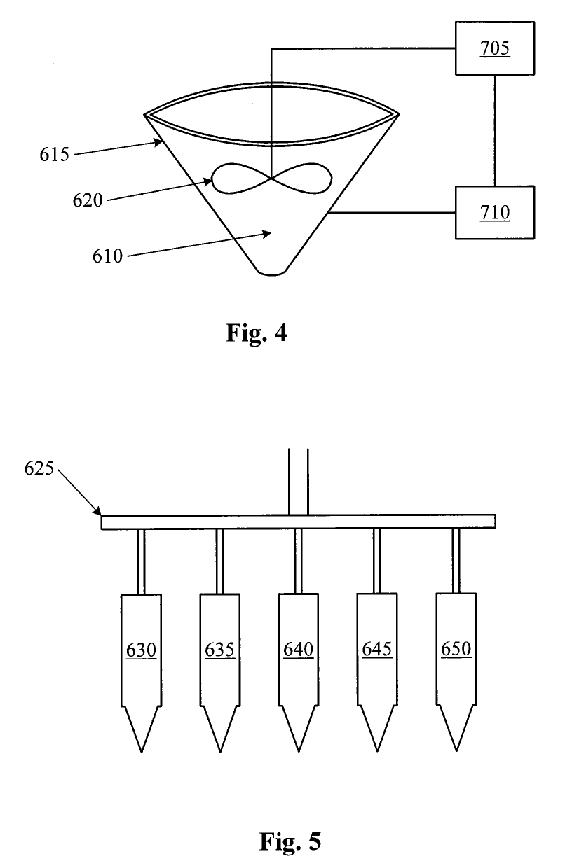

FIG. 4 is a heated mixing container according to the principles of the present invention. Container 610 is adapted to receive a drug/compound mixture. A temperature control device 615, such as a heater, surrounds containers 610. A mixer 620 is disposed in container 610 to keep its contents properly mixed. A motor or drive 705 is connected to mixer 620. Controller 710, similar to controller 305 previously described, controls the operation of temperature control device 615 and motor/drive 705.

FIG. 5 is a set of dispensers according to the principles of the present invention. As shown, distribution manifold 625 is fluidly coupled to dispensers 630, 635, 640, 645, and 650. Distribution manifold 625 can be of any convenient shape. Typically, distribution manifold 625 is hollow and made of tubing.

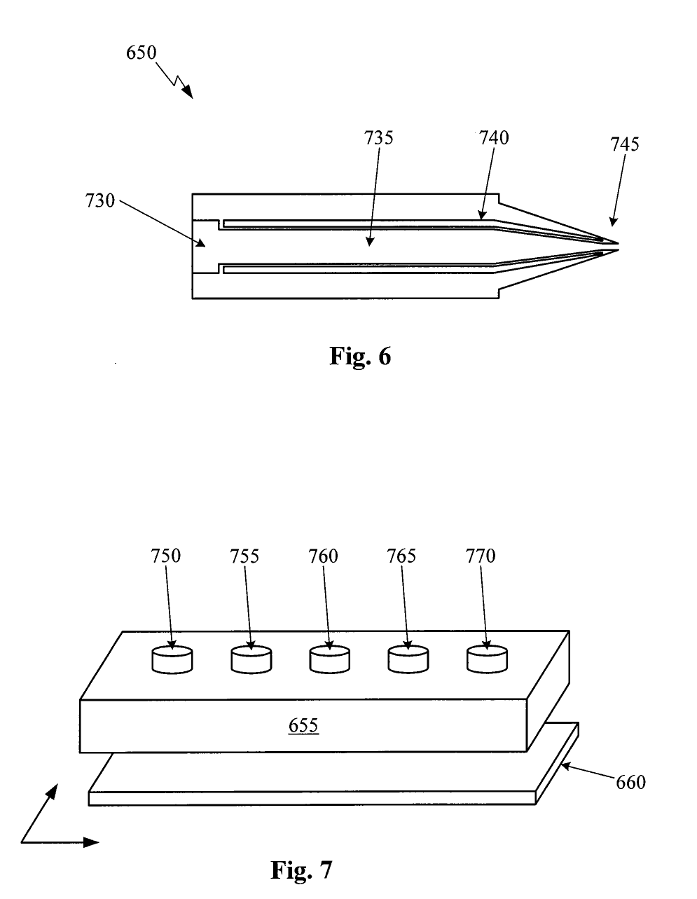

FIG. 6 is a cross section view of a dispenser according to the principles of the present invention. Dispenser 650 includes a port 730, a chamber 735, a temperature control device 740, and a dispensing tip 745. Chamber 735 holds the drug/compound mixture. Temperature control device 740, which can be a heater with a thermal probe of some fore (i.e. thermocouple or thermistor), at least partially surrounds chamber 735 and keeps the mixture at a temperature suitable for dispensing. The mixture is fed into dispenser 650 through port 730. Any of a number of different dispensing mechanisms (not shown), such as a motor, plunger, shape changing material, or the like, may be used to dispense precise amounts of the mixture into mold 655.

FIG. 7 is a mold and bottom plate according to the principles of the present invention. Mold 655 has cavities 750, 755, 760, 765, and 770. Each cavity is configured to receive an amount of drug/compound mixture that corresponds to a pellet. The cavities can be of any suitable shape to form a like-shaped pellet. Bottom plate 660 is removable from mold 655.

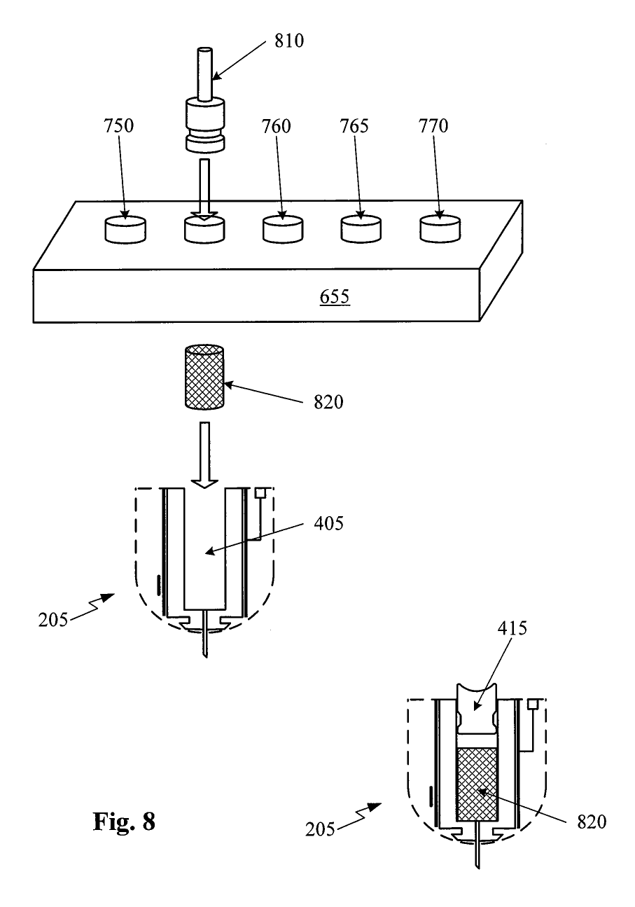

FIG. 8 is a view of the pellet removal process according to the principles of the present invention. In one embodiment, a plunger 810 is used to dislodge a pellet 820 from mold 655 and into the dispensing chamber 405. After the pellet 820 is located in dispensing chamber 405, plunger 415 is placed in dispensing chamber 405. The tip segment 205 is then properly dosed and ready to be used. In other embodiments, the plunger 810 that is used to dislodge pellet 820 is the same plunger that is used in the final assembly of tip segment 205 (and denoted as 415).

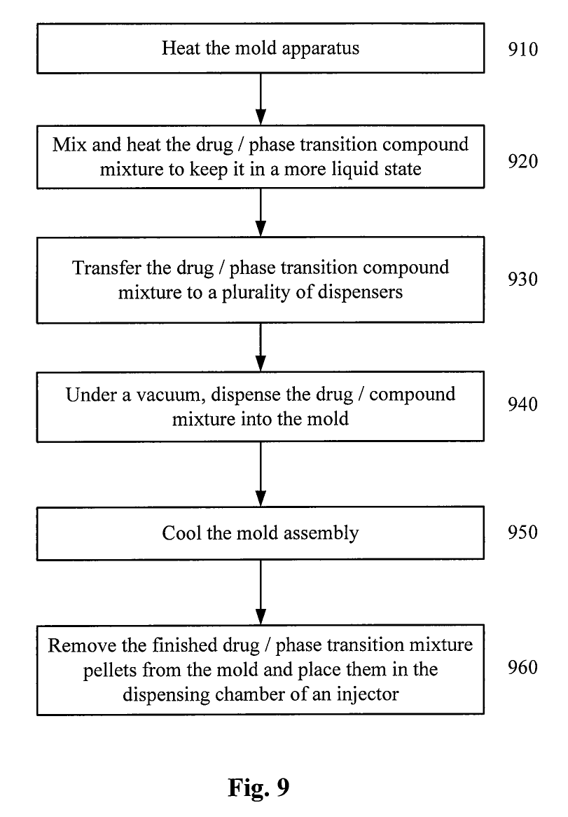

FIG. 9 is a flow chart of a method of molding pellets with a mold assembly according to the principles of the present invention. In 910, the apparatus is heated. In 920, the drug/phase transition compound mixture is heated and mixed to keep it in a less viscous state. In 930, the drug/compound mixture is transferred into a plurality of dispensers. In 940, the drug/compound mixture is dispensed under vacuum into a mold. In 950, the mold is cooled. In 960, the finished drug/compound pellets are removed from the mold and placed in the dispensing chamber of an injector.

From the above, it may be appreciated that the present invention provides an improved system for preparing drug dosage. The present invention provides an apparatus that is designed to reliably make pellets of a consistent quality. This apparatus is configured to form pellets from a drug/compound mixture that is solid at room temperature but liquid at other temperatures. The finished pellets are of the proper size to produce a reliable dosage when injected into the eye.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A mold apparatus comprising:
a container;
a temperature control device at least partially surrounding the container;
a distribution manifold located downstream from the container;
a plurality of dispensers coupled to the distribution manifold;
a mold comprising a plurality of cavities for receiving a mixture from the plurality of dispensers;
a bottom plate located on a bottom surface of the mold; and
a vacuum chamber for keeping the container, distribution manifold, plurality of dispensers and mold in a vacuum;
wherein a drug and compound mixture are brought to a temperature other than room temperature and dispensed into the mold under a vacuum to form pellets.

2. The apparatus of claim 1 further comprising:
a mixer located in the container.

3. The apparatus of claim 2 further comprising:
a drive for driving the mixer.

4. The apparatus of claim 3 further comprising:
a controller for controlling the operation of the mixer and the temperature control device.

5. The apparatus of claim 1 wherein the bottom plate and mold are made of a material that is approved for contact with the drug being formed.

6. The apparatus of claim 1 wherein the temperature control device is a heater coupled with a thermal probe.

7. The apparatus of claim 1 wherein each of the dispensers comprise:
a port coupled to the distribution manifold;
a chamber; and
a temperature control device at least partially surrounding the chamber.

8. The apparatus of claim 7 wherein the temperature control device is a heater coupled with a thermal probe.

9. The apparatus of claim 1 further comprising:
a plunger for removing a finished pellet from the mold.

10. A mold apparatus comprising:
a container;
a mixer located in the container;
a drive for driving the mixer;
a temperature control device at least partially surrounding the container;
a controller for controlling the operation of the mixer and the temperature control device;
a distribution manifold located downstream from the container;
a plurality of dispensers coupled to the distribution manifold;
a mold comprising a plurality of cavities for receiving a mixture from the plurality of dispensers;
a bottom plate located on a bottom surface of the mold; and
a vacuum chamber for keeping the container, distribution manifold, plurality of dispensers and mold in a vacuum;
wherein a drug and compound mixture are brought to a temperature other than room temperature and dispensed into the mold under a vacuum to form pellets.

11. The apparatus of claim 10 wherein the bottom plate and mold are made of a material that is approved for contact with the drug being formed.

12. The apparatus of claim 10 wherein the temperature control device is a heater coupled with a thermal probe.

13. The apparatus of claim 10 wherein each of the dispensers comprise:
a port coupled to the distribution manifold;
a chamber; and
a temperature control device at least partially surrounding the chamber.

14. The apparatus of claim 13 wherein the temperature control device is a heater coupled with a thermal probe.

15. The apparatus of claim 10 further comprising:
a plunger for removing a finished pellet from the mold.

16. A method of making drug/compound pellets comprising:
heating a mold apparatus;
mixing a drug and phase transition compound;
heating the mixture of the drug and phase transition compound;
transferring the mixture into a plurality of dispensers;
under a vacuum, dispensing the mixture into the mold;
cooling the mold; and
removing a finished pellet from the mold.

17. The method of claim 16 further comprising:
loading the finished pellet into an injection device.

18. The method of claim 17 wherein removing the finished pellet from the mold and loading the finished pellet into the injection device further comprises using a plunger to dislodge the finished pellet from the mold and into a dispensing chamber in the injection device.

19. The method of claim 16 further comprising:
removing a bottom plate from the mold.
